(19) United States
(12) Patent Application Publication
(10) Pub. No.: US 2024/0368809 A1
(43) Pub. Date: Nov. 7, 2024

(54) RECYCLED NYLON FOR USE IN GARMENTS

(71) Applicant: Gangadhar JOGIKALMATH, Chestnut Hill, MA (US)

(72) Inventor: Gangadhar JOGIKALMATH, Chestnut Hill, MA (US)

(21) Appl. No.: 18/686,428

(22) PCT Filed: Aug. 26, 2022
(86) PCT No.: PCT/US22/75490

§ 371 Date: Feb. 25, 2024

Related U.S. Application Data
(60) Provisional application No. 63/237,502, filed on Aug. 26, 2021.

(51) Int. Cl. D01F 6/90; D03D 15/283

(52) U.S. Cl. CPC D01F 6/905; D03D 15/283; D10B 2331/021

(57) ABSTRACT

Provided are polymer materials that have a decreased crystallinity relative to nylon 6 and/or nylon 66. The decreased crystallinity is caused by disruption of the hydrogen bond network of the polymeric material. Also provided are fibers and fabrics made from same.

### CROSS REFERENCE TO RELATED APPLICATIONS

This application claims priority to U.S. Provisional Application No. 63/237,502, filed on Aug. 26, 2021, the disclosure of which is incorporated herein by reference.

### FIELD OF THE DISCLOSURE

The present disclosure relates to compositions, articles, and methods of making melt spun fibers with unique properties.

### BACKGROUND OF THE DISCLOSURE

Modern textiles are made with synthetic and natural fibers. Natural fibers offer comfort and breathability while synthetic fibers offer durability. The modern textiles are often made with a blend of natural and synthetic fibers. Many apparel are made with these blends also need other materials to bring about attributes that are not possible by the blends used. Use of such multi-material approach makes it difficult for such apparel to be recycled at the end of their life. An ideal fabric or apparel will have all its constituents parts made with one single material. Unfortunately due to the limitations of chemical nature of the materials used in making these fibers, the mechanical properties that are possible are often limited. For example: cotton can provide wicking of moisture and breathability due to its uneven fiber surface and hydrophilic functional groups. Nylon provides extreme durability and abrasion resistance due to its hydrogen bonding between chains and polyester (PET) provides colorfastness and strength due to the nature of the backbone chemistry containing stiff and soft blocks. Modern apparel also needs a stretchability to aid in making the fabrics more comfortable. Often the only fiber that can allow such property is a polyurethane fiber known as spandex or elastane. These fibers are often made using solution based spinning processes which by themselves are environmentally unfriendly and often result in fabrics that are rendered unrecyclable. Spandex based fabrics often end up in landfill. The use of elastane is resulting in fabrics being sent to landfill after their use causing a significant environmental impact since fossil fuel needs to be used to create newer fibers for producing newer fabrics.

What is needed however is apparel that is made with one single material so that at the end of the life of the fabric, the entire apparel can be recycled in one single stream. Such material needs to be able to be made into a strong fiber, an elastic fiber and a combination there of providing a gamut of properties that can be tuned for different apparel applications.

Ideal elastomers made with thermoplastic properties have two desirable properties: one elastic segment which is coupled to a crystallizable long segment of a condensation polymer (nylon, PET). The crystallizable segment forms small crystals (owing to its small size) and acts as physical crosslinks. These physical cross-links are meltable thus enabling the creation of a recyclable thermoplastic elastomer. Many such elastomers exist in the market. Investment in polymerization equipment and expertise is required to create these polymers. Nylon based elastomers are other example where in polyether segments act as rubber to nylon crystal crosslinks. Many such options are available in the market (PEBAX polymers from Arkema for example).

These polymers are very expensive and require care while processing and their recyclability is limited to certain number of cycles. Such elastomers are not durable and are ill equipped to form articles that require robust mechanical properties.

Another disadvantage of such polymers is the fact that these polymers are made with multiple monomers. This fact makes it nearly impossible to depolymerize and separate the monomers and reconstruct the polymers again. Such polymers once used will be headed to landfill.

### BRIEF SUMMARY OF THE DISCLOSURE

In a first embodiment, a composition is provided. The composition includes one or more polymers and one or more associative compounds that interacts (e.g., reacts, or otherwise interacts covalently or non-covalently (e.g., electrostatically and/or via hydrogen bonding and/or the like)) with the first polymer and modifies (e.g., alters) the properties of first polymer. A polymer and one or more associative compounds may form a fiber and subsequently a fabric. The associative compounds are referred to as associative compounds because they associate with the one or more polymers. In various embodiments, the association is covalent association (e.g., bonding).

In a second embodiment, a fabric is provided. The fabric has a plurality of fibers which are made with a polymer combined with a reactant. In some embodiments, this fabric may be woven. Such fabrics or fibers are tunable in terms of mechanical properties by the choice of or amount of reactants that is added to the first polymer

The associative compounds can be melt blended with one type of polymer. For example, such a polymer can be nylon, polyester, polypropylene, polycarbonate, polyacetal, and combinations thereof. In various examples, the polymers have an Mₙ and/or M_{w} of least 5,000 Da, but less than 1,000,000 Da. In various examples, the polymers have an Mₙ and/or M_{w} of 10,000 Da to 100,000 Da, including all 0.1 Da values and ranges therebetween. In various embodiments, the polymers have a relative viscosity of 1.5 or higher. For example, the polymer can also be polyolefins, polystyrenes, other such polymers, and other combinations thereof capable of forming fibers. Such fibers containing associative compounds are referred to as first fibers.

The fabric can be made of two different types of fibers. The different types of fibers can be referred to as different sets of fibers (i.e., the first fiber describes a fiber from the first set of fibers). In other embodiments, the first and second fibers also can form a bicomponent fiber. The fabric may be formed by weaving, crocheting, knitting, felting, spinning, or any combination thereof.

Meltable associative compounds described herein may be anchored to a polymer matrix of an article or finished product, and are stably and uniformly distributed therein. Groups may be “anchored” to the polymer via covalent or non-covalent interactions. For example, associative compounds, such as, for examples, compounds having epoxides, carboxylic acids, or anhydrides may be covalently reacted with the polymer to anchor the associative compound to the polymer. Anchoring the associative compounds to the polymer matrix can alter the mechanical properties of the resulting article such as fiber. As long as the associative compounds are capable of melting, mixing, and integrating with the polymer matrix during mixing, the reactant molecule may be carried along and distributed within the matrix. That is, in various embodiments, the associative compounds do not phase separate and form one uniform phase with the polymer following mixing and melting.

In some embodiments, reactants are attached to the polymer molecules via either covalent, electrostatic, hydrogen bonding, or van der Waals interactions prior to addition into the polymer matrix. In other embodiments, the reactants may be reacted or bound to a polymer during the processing (e.g., profile extrusion, molding, thermoforming, fiber extrusion, blow molding, and the like) of the polymer article. In these embodiments, both the reactant and the polymer may be separately added during processing of the polymer into a final article.

### BRIEF DESCRIPTION OF THE FIGURES

FIG. 1 shows shish-Kebab structure formation in the direction of stress (fiber axis) as formed from melt.

FIG. 2 shows crystallite formation in fibers from a polymer melt. (A) shows an amorphous structure, (B) shows an oriented structure, (C) shows a non-oriented crystalline structure; and (D) shows an oriented crystalline structure.

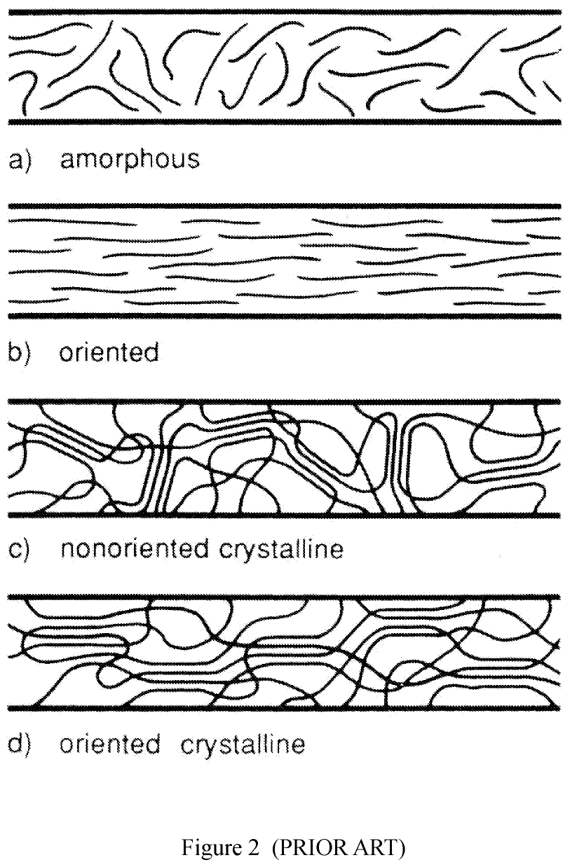

FIG. 3 shows a closer view of a boundary between crystalline and the amorphous regions in nylon. “D” refers to deuterium.

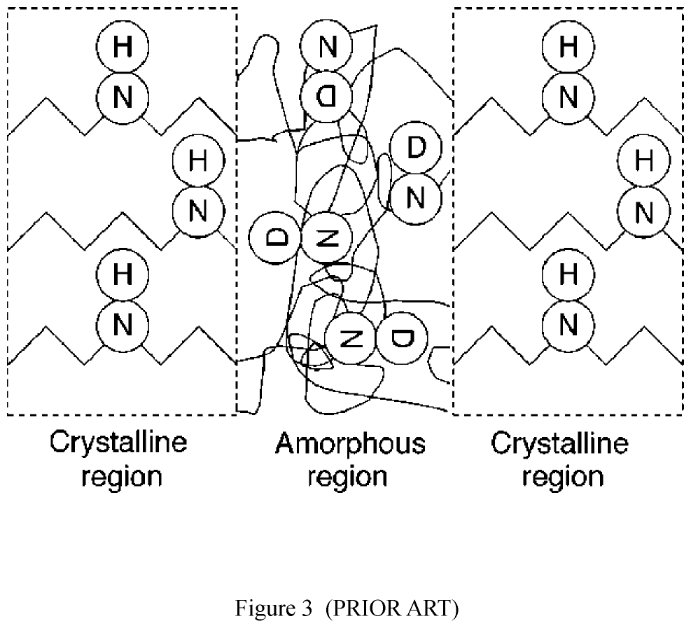

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

The present invention may be understood more readily by reference to the following description taken in connection with the accompanying Examples, all of which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer to compositions and methods of making and using the compositions. That is, where the disclosure describes and/or claims a feature or embodiment associated with a system or apparatus or a method of making or using a system or apparatus, it is appreciated that such a description and/or claim is intended to extend these features or embodiment to embodiments in each of these contexts (i.e., system, apparatus, and methods of using).

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “approximately,” it will be understood that the particular value forms another embodiment. In general, use of the term “approximately” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “approximately.” In other cases, the gradations used in a series of values may be used to determine the intended range available to the term “approximately” for each value. Where present, all ranges are inclusive and combinable. That is, references to values stated in ranges include every value within that range.

In general, when a range is presented, all combinations of that range are disclosed. For example, 1 to 4 includes not only 1 to 4 but also 1 to 2, 1 to 3, 2 to 3, 2 to 4 and 3 to 4.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). Illustrative examples of groups include:

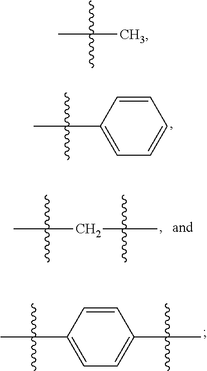

As used herein, unless otherwise indicated, the term “alkyl” refers to branched or unbranched saturated hydrocarbon groups. Examples of alkyl groups include, but are not limited to, methyl groups, ethyl groups, propyl groups, butyl groups, isopropyl groups, tert-butyl groups, and the like. For example, the alkyl group can be a C₁ to C₁₂ group, including all integer numbers of carbons and ranges of numbers of carbons therebetween (e.g., C₁, C₂, C₃, C₄, C₅, C₆, C₇, C₈, C₉, C₁₀, C₁₁, or C₁₂). The alkyl group can be unsubstituted or substituted with one or more substituent. Examples of substituents include, but are not limited to, various substituents such as, for example, halogens (—F, —Cl, —Br, and —I), aliphatic groups (e.g., alkyl groups, alkenyl groups, alkynyl groups), aryl groups, alkoxide groups, carboxylate groups, carboxylic acids, ether groups, and the like, and combinations thereof.

As used herein, unless otherwise indicated, the term “aliphatic” refers to branched or unbranched hydrocarbon groups that, optionally, contain one or more degrees of unsaturation. Degrees of unsaturation can arise from, but are not limited to, aryl groups and cyclic aliphatic groups. For example, the aliphatic groups/moieties are a C₁ to C₃₀ aliphatic group, including all integer numbers of carbons and ranges of numbers of carbons therebetween (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, C₂₀, C₂₁, C₂₂, C₂₃, C₂₄, C₂₅, C₂₆, C₂₇, C₂₈, C₂₉, or C₃₀). The aliphatic group can be unsubstituted or substituted with one or more substituent. Examples of substituents include, but are not limited to, substituents such as, for example, halogens (—F, —Cl, —Br, and —I), aliphatic groups (e.g., alkyl groups and the like), halogenated aliphatic groups (e.g., trifluoromethyl group), aryl groups, halogenated aryl groups, substituted amine groups, carboxylic acids groups, protected alcohol groups, ether groups, ester groups, thioether groups, thioester groups, substituted carbamate groups, substituted amide groups, alkenes with a long alkyl chain between connecting it to the epoxide, and the like, and combinations thereof.

The engineering polymers such as Nylon and PET are highly regular linear molecules capable of packing into crystallites when cooled from melt. The presence of hydrogen bonds between neighboring chains results in a strong polymer. This property while advantageous for durability and high tenacity, prevents elongation and recovery of the article under stretch. The technical challenge here is to introduce elasticity into the molecule of nylon and polyester to enable stretch/recovery properties in the bulk article made with such polymer. The present disclosure provides elastomers with a disrupted crystal formation such that the hardness of the resulting elastomer is lower than the precursor polymer to overcome the problems of diminished elongation and recovery.

In an aspect, the present disclosure provides compositions, which may be fibers. The composition comprises one or more polymers and one or more associative compounds. An associative compound can be defined as a chemical structure having either a single or multiple functional groups complimentary to those available on polymers, such as, for example, Nylon and PET.

The present disclosure polymer materials or polymer compositions that comprise one or more polymers and one or more associative compounds. Also provided are fibers made therefrom. However, the composition may be used in other articles than a fiber. For example, the composition may be used in an article formed by extrusion, fiber melt spinning, or injection molding. Without intending to be bound by any particular theory a reaction can occur during the melt. Association via hydrogen bonding and/or electrostatics can occur in melt and during cool down of the polymer from the melt.

The present disclosure provides polymer materials and compositions (e.g., nylon yarns) with elastic recovery. Materials of the present disclosure have been measured via the Shore hardness scale. The resulting material has a Shore hardness level less than the unmodified polymer. The hardness and elasticity is affected by disrupting the crystal structure of the polymer fibers (e.g., nylon yarns).

In various embodiments, the polymer materials may comprise a plurality of domains. Each domain may be crystalline, amorphous, semi-crystalline, non-oriented crystalline, or oriented crystalline.

Examples of polymers include nylon, nylon-based polymers, nylon-like polymers, polyethylene terephthalate (PET), PET-based polymers, and PET-like polymers. For example, the polymers may be nylon 6, nylon 11, nylon 12, nylon 12, or nylon 66. In various embodiments, the nylon is a blend of oligoamines, low molecular weight nylons with other polyamides that have different carbon atom spacing between the CO and NH groups. In various embodiments, the polymers may have one or more pendant functional groups that are sidechains of the nylon polymer. The pendant functional groups may have a reactive group, such as, for example, an amine, acid, thiol, alcohol, ester, azide, or alkyne. Chemistry may be performed one or more of the pendant functional groups such that, for example, an associative compound is functionalized to the reactive group. For example, an associative compound may be conjugated to the pendant functional group via acylation chemistry, click chemistry, and the like. Other suitable chemistries are known in the art and are contemplated by the present disclosure.

In various other embodiments, the polymers can be nylon, polyester, polypropylene, polycarbonate, polyacetal, and combinations thereof. In various examples, the polymers have an Mₙ and/or M_{w} of least 5,000 Da, but less than 1,000,000 Da. In various examples, the polymers have an Mₙ and/or M_{w} of 10,000 Da to 100,000 Da, including all 0.1 Da values and ranges therebetween. In various embodiments, the polymers have a relative viscosity of 1.5 or higher.

Various associative compounds may be used. Examples include compounds having anhydrides, carboxylic acids, or acid chlorides, and the associative compounds may be either monofunctional or bifunctional (e.g., have one or more of the aforementioned functional groups). Alternatively, associative compounds may be short chain epoxides or other aliphatic epoxides. Examples of short chain epoxides include, but are not limited to, Erisys GE-23 (diglycidyl ether based on dipropylene glycol); Erisys GE-24 (diglycidyl ether based on polypropylene glycol); Erisys GE35 and GE35H (triglycidyl ethers based on Castor Oil (GE-35H has a lower modulus than GE-35)); Erisys GE-36 (triglycidyl ether based on propoxylated glycerin); and Erisys GS-120 (diglycidyl ester based on dimer acid).

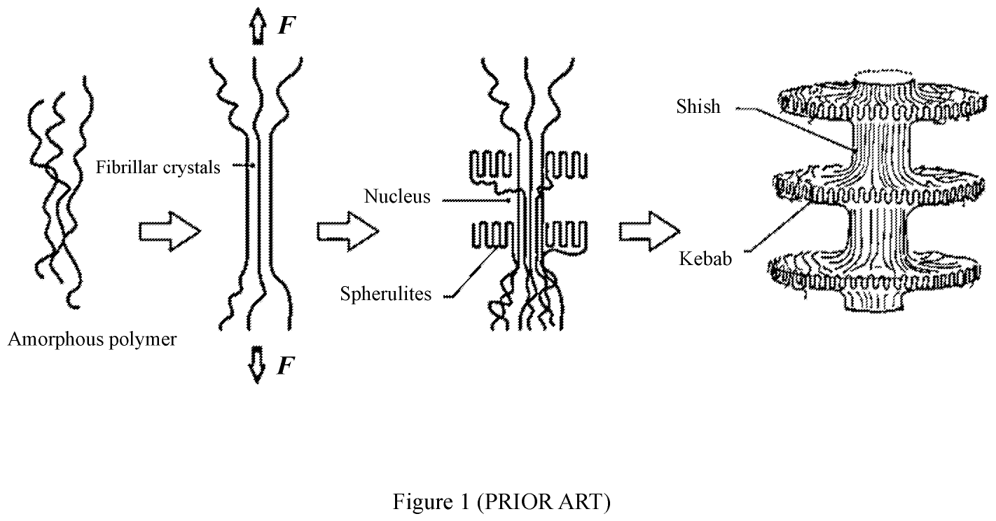

The intermolecular bonds create highly packed chains that cannot be easily stretched. The present disclosure provides polymers where the hydrogen bond network has been disrupted by introducing moieties that are not covalently linked to the polymer (e.g., nylon). For example, a shorter chain polyamide (an oligomer) or a molecule containing multiple amines can be used as an interacting group and is contacted with the polymer and competes for the hydrogen bonds of the polymer (e.g., nylon). Such disruption in turn reduces the crystallinity (See FIG. 1) and enable chain mobility and relaxation. The amount of the architecture of hydrogen bond disruptors (e.g., associative compounds) can be varied to yield yarns with different amounts of orientation and crystallinity and evaluate the resulting tenacity/elongation/stretch/recovery. For example, reducing the amount of crystallization will increase the elongation capacity of the resulting polymer and associative compound material.

In various embodiments, an additional approach is to disrupt the crystalline structure using a soft segment polymer. In various examples, soft segments with end caps of functional groups are mixed with the polymer and these can associate with polymer (e.g., nylon). The functional groups of the end caps may be, for example, aldehydes, epoxides, acid chlorides, amines (e.g., primary amines or secondary amines), alcohols, or any combination thereof (e.g., one end group is a primary amine, and the other end group is an aldehyde). The functional groups on the ends of the soft segment will enable a labile physical crosslink that disrupt the crystalline structure, but would also cushion the molecules during application of stretch resulting in an elastic deformation and recovery. In various examples, the soft segment is a nylon, nylon-based polymer, nylon-like polymer, PET, PET-based polymer, PET-like polymer, where the soft segment is modified with the end caps as described herein.

The present disclosure further provides intersperse elastomeric components that can be reacted with the polymer to enable elastic recovery post-stretch. For example, these non-limiting examples of these components include epoxidized polyisoprene, reactive natural rubber (epoxy-based), and epoxidized polybutadienes.

In various embodiments, the associative compounds mentioned comprise an elastomeric component, which may be aliphatic, that has a reactive group that can react with the functional groups present on nylon. Such molecules have a melting point in the range of approximately −50° C. to 400° C. Such associative compounds can then be melt compounded with a polymer such as nylon and polyester.

In an example, the associative compounds used is an epoxidized elastomer such as epoxidized isoprene.

An associative compound disrupts the hydrogen bonds between nylon molecules and thereby making the article more flexible is used in the composition. Either by itself or in combination with the elastomeric reactant. Examples include, but are not limited to, short chain oligomers of polyamides, aliphatic amines (e.g., diethylamine, propylamine), short chain and long chain fatty acid amines (e.g., octadecylamine), acids (e.g., aliphatic acids, such as, for example, octanoic acid), and fatty acids (e.g., oleic acid, stearic acid, linoleic acid, palmitic acid, and the like). The aliphatic amines may be diamines.

In various embodiments, the associative compounds have more than one reactive group per molecule that makes them crosslink (covalently or non-covalently) the backbone resulting in an elastomeric material but hard to recycle. Competitive reactive species can allow the ability to control the reactivity of the backbone towards the reactive elastomeric component. Examples of competitive reactive species include epoxy-based associative compounds described herein (such as, but not limited to, the short chain epoxides described herein). Because the diffusion and mobility of the molecules is related to their size, a smaller reactive molecule has the ability to migrate and bond to anchor groups via, for example, covalent bonds on the backbone before a larger reactive molecule does. Small reactive molecules may have an Mₙ and/or M_{w} less than 5 kDa. In various examples, the mass is 200 Da to 2000 Da, including all 0.1 Da values and ranges therebetween.

In an embodiment, PA6 is mixed with a very small amount of epoxidized polyisoprene (natural rubber). When mixed together, they form an elastomeric compound but the compound is crosslinked and not being able to recycle. Mixing may be mechanical shear mixing. But the same components when mixed with 0.1% to 15% by weight (including all 0.1% values and ranges therebetween (e.g., 5-15% by weight)) of an amount of mono functional epoxy molecule (such octadecyl-epoxy) or amine-end capped C18, the smaller molecules either binds to the end groups of nylon or to the epoxy group on the elastomer thereby reducing the likelihood of crosslink formation. The amount may change depending on the mass of the compound. For example, large compounds may require less whereas smaller compounds will require more. Without intending to bound by any particular theory, it is considered the resulting material would thus exhibit recyclable properties because of the disrupted crystal structure.

The reactivity competition could be exploited by changing the ratio of the associative compounds to polymer.

A mixture of associative compounds with various amount of elasticity could be added to control the overall elastomeric nature of the resulting compound. For example, mixing short chain epoxides and long chain epoxides can create a competitive reaction to the amine groups on nylon. If the reaction mixture has more short chain epoxides, the modification of nylon would be by the short chains and the resulting compound would not be very elastomeric in nature. However, the reverse is true if there are more longer chain epoxides in the reaction mixture. There is a higher probability of the long chain epoxide reacting with nylon thus creating a more elastomeric construct.

Other categories of associative compounds include molecules that can disrupt hydrogen bond formation in crystalline polymers. These could be spacer molecules that are aliphatic amine based. For example, ethylenediamine (1, 2-diaminoethane) and its condensed forms, di-ethylenetriamine, triethylenetetramine, or tetraethylenepentamine, HMDA (hexamethylenediamine) or a combination of these could be used.

Additionally, salts such as GaCl₃ could be used to disrupt the hydrogen bonds in nylon. In various examples, the salt has a cation that complexes with the CO bond of an amide linkage.

In another example, a combination of associative compounds and other species that disrupt hydrogen bonds are used. For examples, the associate compounds and other species are used in various weight ratios (e.g., 1 to 4, which includes not only 1 to 4 but also 1 to 2, 1 to 3, 2 to 3, 2 to 4 and 3 to 4) or various percentages, where the reactant compound is 0.1 to 99.9% by weight, including all 0.1% values and ranges therebetween, and 0.1 to 99.9% by weight, including all 0.1% values and ranges therebetween.

One or more associative compounds, including examples such as epoxidized isoprene, can be melt blended with nylon 6 and 66 in various weight ratios from 0.5% to 35%, including all ranges and values to the 0.1% therebetween. The weight ratio of epoxidized isoprene can be from 5% to 25%, 5% to 20% by weight, or preferably 5% to 15% by weight. While mentioned with respect to types of nylon, the elastomeric compound or compounds can be melt blended in various ratios from 0.1 to 35% by weight (e.g., 0.5% to 35% by weight), including all ranges and values to the 0.1% therebetween, where another material (e.g., nylon 6 and/or nylon 66) comprises the remaining percentage by weight.

In a second aspect, the present disclosure provides a fabric. The fabric has a plurality of fibers comprising one or more polymers and one or more associative compounds. In various embodiments, the fabric may be formed by weaving, crocheting, knitting, felting, spinning, or any combination thereof. In various embodiments, the fabric is woven.

The fabric can be made of two different types of fibers. The different types of fibers can be referred to as different sets of fibers (i.e., the first fiber describes a fiber from the first set of fibers) For example, the first fibers, which can include the reactant compositions, can be nylon 6 and the second fibers can be nylon 6 which do not include reactant compositions. In various other examples, the first fiber has the Nylon pre-reacted with a reactant or a associative compound, while the second fiber does not. The first and second fibers also may be the same. For example, the first and second fibers can be nylon. Nylon 6 and nylon 66 may be used, but other nylons may be utilized. In an example, the first fiber comprises 0.1 to 25% by weight of the fabric, including all 0.1% values and ranges therebetween, and the second fiber comprises 75 to 99.9% by weight of the fabric, including all 0.1% values and ranges therebetween, where the total percent by weight of the fabric is 100%. In another example, the first fiber comprises 0.1 to 10% by weight of the fabric, including all 0.1% values and ranges therebetween, and the second fiber comprises 90 to 99.9% by weight of the fabric, including all 0.1% values and ranges therebetween, where the total percent by weight of the fabric is 100%.

In certain embodiments, the first fibers may be spiral wound on the second fibers. The first fibers also may be woven in the same or an orthogonal direction to the second fibers. In other embodiments, the first and second fibers also can form a bicomponent fiber. In an example, the first fiber comprises 0.1 to 25% by weight of the bicomponent fiber, including all 0.1% values and ranges therebetween, and the second fiber comprises 75 to 99.9% by weight of the bicomponent fiber, including all 0.1% values and ranges therebetween, where the total percent by weight of the bicomponent fiber is 100%. In another example, the first fiber comprises 0.1 to 10% by weight of the bicomponent fiber, including all 0.1% values and ranges therebetween, and the second fiber is 90 to 99.9% by weight of the bicomponent fiber, including all 0.1% values and ranges therebetween, where the total percent by weight of the bicomponent fiber is 100%. Without intending to be bound by any particular theory, it is considered that wound fibers have less strength than twisted fibers. Although spiral wound fibers protect the inner fiber while in twisted fibers, both fibers are exposed to abrasion.

In an example, different types of reactive chemistries are utilized, such as covalent bonding between the following pairs of reactants: epoxide-amine, epoxide-anhydride, anhydride-hydroxyl, anhydride-amine, amine-isocyanate, hydroxyl-isocyanate, or isocyanate-anhydride. Additional examples of possible pairs of reactions include, but are not limited to, acid chloride-amine, epoxy-phenol, epoxy-carboxylic acid, arene-anhydride, aldehyde-amine, ketone-amine, ester-amine, and alkyl halide-amine.

In an aspect, a method of weaving. A plurality of first fibers and a plurality of second fibers of a second polymer are provided and weaved to form a composition. The polymer of the first fiber is configured to be more elastic than the second by use of reactive compounds (reactants). The first fibers and second fibers are woven to form a fabric. In an example, the first fiber comprises 0.1 to 25% by weight of the fabric, including all 0.1% values and ranges therebetween, and the second fiber comprises 75 to 99.9% by weight of the fabric, including all 0.1% values and ranges therebetween, where the total percent by weight of the fabric is 100%. In another example, the first fiber comprises 0.1 to 10% by weight of the fabric, including all 0.1% values and ranges therebetween, and the second fiber comprises 90 to 99.9% by weight of the fabric, including all 0.1% values and ranges therebetween, where the total percent by weight of the fabric is 100%.

The first fibers may be spiral wound on the second fibers. The first fibers also may be woven in the same or an orthogonal direction to the second fibers. The first and second fibers also can form a bicomponent fiber. In an example, the first fiber comprises 0.1 to 25% by weight of the bicomponent fiber, including all 0.1% values and ranges therebetween, and the second fiber comprises 75 to 99.9% by weight of the bicomponent fiber, including all 0.1% values and ranges therebetween, where the total percent by weight of the bicomponent fiber is 100%. In another example, the first fiber comprises 0.1 to 10% by weight of the bicomponent fiber, including all 0.1% values and ranges therebetween, and the second fiber is 90 to 99.9% by weight of the bicomponent fiber, including all 0.1% values and ranges therebetween, where the total percent by weight of the bicomponent fiber is 100%.

In some embodiments, associative compounds are attached to the nylon molecules via either covalent, electrostatic, or van der Waals interactions in a separate step prior to addition into the polymer matrix. In this way, many more associative compounds can be added to the nylon molecules which if added into the polymer matrix of nylon during processing may crosslink the whole mass of polymer thus reducing any chances of forming articles with the polymer. In other embodiments, the associative compounds may be reacted or bound to an anchor during the processing of adding the reactant to the polymer article. In these embodiments, both the associative compounds or the associative compound-bound nylon may be separately added during processing of the polymer into a final article.

The associative compounds may be tuned to the chemical environment of the polymer article. For example, the associative compounds may have a substantially similar chemical structure as that of the polymer matrix and/or be compatible with the polymer. The associative compounds may be a separate entity from the polymer allowing the final product to be easily recycled.

The following Statements provide various embodiments of the present disclosure.

Statement 1. A polymeric composition comprising: one or more polymer (e.g., one or more nylon, nylon-like polymer, nylon-based polymer, PET, PET-based polymer, PET-like polymer, or combination thereof); and one or more associative compounds and/or hydrogen bond disrupting species, wherein the polymeric composition has a crystallinity that is at least 5% less (e.g., at least 10% less, at least 15% less, at least 20% less, at least 25% less, at least 30% less, at least 35% less, at least 40% less, or at least 50% less) than a nylon polymer and the one or more associative compounds and/or hydrogen bond disrupting species are present at a concentration of 0.1-35% by weight.

Statement 2. A polymeric composition according to Statement 1, wherein the nylon polymer is nylon 6 or nylon 66.

Statement 3. A polymeric composition according to any one of Statements 1 or 2, wherein the crystallinity is at least 10% less than nylon.

Statement 4. A polymeric composition according to any one of the preceding Statements, wherein the one or more associative compounds are covalently attached to the one or more polymers.

Statement 5. A polymeric composition according to any one of Statements 1-3, wherein the one or more associative compounds are not covalently attached to the one or more polymer. Statement 6. A polymeric composition according to claim 1, wherein the associative compound is a short chain polyamide terminally modified such that one or more termini of the short chain polyamide has at least one functional group chosen from aldehydes, epoxides, acid chlorides, amines, alcohols, or combinations thereof.

Statement 7. A polymeric composition according to any one of the preceding Statements, wherein the associative compound is chosen from polyamides, aliphatic epoxides, aliphatic amines, propylamine, short chain and long chain fatty acid, aliphatic acids, and fatty acids.

Statement 8. A polymeric composition according to Statement 7, wherein the aliphatic amine is chosen from ethylenediamine (1,2-diaminoethane) and its condensed forms, diethylenetriamine, triethylenetetramine, or tetraethylenepentamine, HMDA, and combinations thereof.

Statement 9. A polymeric composition according to Statement 7, wherein the aliphatic epoxide is epoxidized polyisoprene, reactive natural rubber (epoxy-based), epoxidized polybutadienes, diglycidyl ethers based on dipropylene glycol, diglycidyl ethers based on polypropylene glycol, triglycidyl ethers based on Castor Oil, triglycidyl ethers based on propoxylated glycerin, and diglycidyl esters based on dimer acid.

Statement 10. The polymeric composition according to any one of the preceding Statements, the hydrogen bond disrupting species is a salt (e.g., a salt where the cation that complexes with the CO bond of an amide linkage).

Statement 11. The polymeric composition according to Statement 10, wherein the salt is GaCl₃.

Statement 12. A fiber comprising the polymeric material according to any one of the preceding Statements.

Statement 13. A fabric comprising a plurality of fibers according to Statement 12.

Statement 14. The fabric according to Statement 13, further comprising one or more different fibers that do not comprise associative compounds and/or hydrogen bond disrupting species.

Statements 15. The fabric according to Statement 14, wherein the one or more different fibers comprise nylon 6 and/or nylon 66.

Statement 16. The fabric according to Statement 13, wherein the fabric is woven, crocheted, knitted, felted, or spun.

Statement 17. The fabric according to Statement 16, wherein the fabric is woven.

Other aspects can be derived from the instant disclosure.

### EXAMPLE

The following example provides stretch and recovery ratios of materials of the present disclosure.

The Crystallinity of the resulting material can be measured using Differential Scanning calorimetry, X-ray diffraction and other such measures. The indirect measurements could include increased elasticity (elongation at break), lowered tensile modulus (typical of elastomers) and improved impact strength (measured using testing such as Izod impact testing. The following data presented in Table 1 were obtained by ASTM D2594.

TABLE 1
Stretch performance of knits produced
using modified and virgin nylon yarns.

| | | | Normalized Stretch/ |
|---|---|---|---|
| Sample | % Stretch | % Recovery | Recovery ratio |
| Control (Nylon6) | 55% | 72% | 1 |
| Nylon6 + 5% Nylon12 | 75% | 66% | 1.5 |

Although the present disclosure has been described with respect to one or more particular embodiments and/or examples, it will be understood that other embodiments and/or examples of the present disclosure may be made without departing from the scope of the present disclosure.

1. A polymeric composition comprising:
one or more nylon, nylon-like polymer, nylon-based polymer; and
one or more associative compounds and/or hydrogen bond disrupting species, wherein the polymeric composition has a crystallinity that is at least 5% less than a nylon polymer and the one or more associative compounds and/or hydrogen bond disrupting species are present at a concentration of 0.1-35% by weight.

2. The polymeric composition according to claim 1, wherein the nylon polymer is nylon 6 or nylon 66.

3. The polymeric composition according to claim 1, wherein the crystallinity is at least 10% less than nylon.

4. The polymeric composition according to claim 1, wherein the one or more associative compounds are covalently attached to the one or more polymers.

5. The polymeric composition according to claim 1, wherein the one or more associative compounds are not covalently attached to the one or more polymer.

6. The polymeric composition according to claim 1, wherein the associative compound is a short chain polyamide terminally modified such that one or more termini of the short chain polyamide has at least one functional group chosen from aldehydes, epoxides, acid chlorides, amines, alcohols, or combinations thereof.

7. The polymeric composition according to claim 1, wherein the associative compound is chosen from polyamides, aliphatic epoxides, aliphatic amines, propylamine, short chain and long chain fatty acid, aliphatic acids, and fatty acids.

8. The polymeric composition according to claim 7, wherein the aliphatic amine is chosen from ethylenediamine (1,2-diaminoethane) and its condensed forms, diethylenetriamine, triethylenetetramine, or tetraethylenepentamine, and combinations thereof.

9. The polymeric composition according to claim 7, wherein the aliphatic epoxide is epoxidized polyisoprene, reactive natural rubber (epoxy-based), and epoxidized polybutadienes.

10. The polymeric composition according to claim 1, the hydrogen bond disrupting species is a salt.

11. The polymeric composition according to claim 10, wherein the salt is GaCl₃.

12. A fiber comprising the polymeric material according to claim 1.

13. A fabric comprising a plurality of fibers according to claim 12.

14. The fabric according to claim 13, further comprising one or more different fibers that do not comprise associative compounds and/or hydrogen bond disrupting species.

15. The fabric according to claim 14, wherein the one or more different fibers comprise nylon 6 and/or nylon 66.

16. The fabric according to claim 13, wherein the fabric is woven, crocheted, knitted, felted, or spun.

17. The fabric according to claim 16, wherein the fabric is woven.
